(19) United States
(12) Patent Application Publication
(10) Pub. No.: US 2021/0270216 A1
(43) Pub. Date: Sep. 2, 2021

(54) Fuel Vapor Processing Apparatus

(71) Applicant: AISAN KOGYO KABUSHIKI KAISHA, Obu-shi (JP)

(72) Inventors: Hiroaki KITANAGA, Obu-shi (JP); Yuya TANIDA, Obu-shi (JP); Hiroyuki TAKAHASHI, Nagoya-shi (JP)

(73) Assignee: AISAN KOGYO KABUSHIKI KAISHA, Obu-shi (JP)

(21) Appl. No.: 17/165,671

(22) Filed: Feb. 2, 2021

(30) Foreign Application Priority Data
Feb. 27, 2020 (JP) 2020-031330

(51) Int. Cl. F02M 25/08

(52) U.S. Cl. CPC F02M 25/0854; F02M 2025/0881; F02M 25/0872

(57) ABSTRACT

A fuel vapor processing apparatus includes a casing forming a flow passage, a first adsorption chamber disposed on one end of the flow passage and configured to store a first adsorbent, a fourth adsorption chamber disposed on the other end of the flow passage and configured to store a fourth adsorbent, and a second adsorption chamber and a third adsorption chamber disposed in series between the first adsorption chamber and the fourth adsorption chamber, the second and third adsorption chambers configured to store a second adsorbent and a third adsorbent, respectively. The first adsorption chamber and the fourth adsorption chamber are disposed adjacent to each other so as to allow heat to be exchanged therebetween.

### CROSS-REFERENCE TO RELATED APPLICATIONS

This application claims priority to Japanese patent application serial number 2020-031330, filed Feb. 27, 2020, the contents of which is hereby incorporated herein by reference in its entirety for all purposes.

### BACKGROUND

Embodiments in the present disclosure relate to a fuel vapor processing apparatus.

Some fuel vapor processing apparatuses may include a casing, a most upstream side adsorption chamber, and a most downstream side adsorption chamber. The casing forms a flow passage, through which an evaporated fuel flows from one end to the other end. The most upstream side adsorption chamber is disposed on one end of the flow passage and stores an adsorbent capable of adsorbing and desorbing evaporated fuel. The most downstream side adsorption chamber is disposed on the other end of the flow passage and stores an adsorbent capable of adsorbing and desorbing evaporated fuel. Further, the fuel vapor processing apparatus is provided with a heat exchanger (air flow channel) between the most upstream side adsorption chamber and the most downstream side adsorption chamber. The heat exchanger has a heat exchange function for exchanging heat between the inside and outside of the flow passage.

### SUMMARY

In accordance with an aspect of the present disclosure, a first embodiment includes a fuel vapor processing apparatus comprises a casing, a most upstream side adsorption chamber, a most downstream side adsorption chamber, and at least one intermediate adsorption chamber. The casing may form a flow passage through which an evaporated fuel flows from one end to the other end of the casing. The most upstream side adsorption chamber may be disposed on one end of the flow passage and may store an adsorbent configured to adsorb and desorb the evaporated fuel. The most downstream side adsorption chamber may be disposed on the other end of the flow passage and may store the adsorbent configured to adsorb and desorb the evaporated fuel. The intermediate adsorption chamber may be disposed in series between the most upstream side adsorption chamber and the most downstream side adsorption chamber. The intermediate adsorption chamber may store an adsorbent configured to adsorb and desorb the evaporated fuel. In the fuel vapor processing apparatus, the casing comprises a main-case including the most upstream side adsorption chamber and the intermediate adsorption chamber; and a sub-case formed separately from the main-case and including the most downstream adsorption chamber. The most downstream adsorption chamber of the sub-case and the most upstream side adsorption chamber are disposed adjacent to each other without a gap on a downstream side than a center of the most upstream side adsorption chamber in the flowing direction of evaporated fuel during adsorption. The most upstream side adsorption chamber and the most downstream side adsorption chamber are configured to exchange heat therebetween.

According to the first embodiment, at the time of adsorption, the most downstream side adsorption chamber may be heated by the transfer of adsorption heat generated by the adsorbent in the most upstream side adsorption chamber. Therefore, the adsorption capacity of the adsorbent in the most downstream adsorption chamber may be reduced, and the amount of adsorption may be reduced. Further, if residual heat remains in the most downstream side adsorption chamber at the time of desorption, the amount of desorption of the adsorbent in the most downstream side adsorption chamber may be larger than that at room temperature. Therefore, the residual amount of the adsorbent remaining in the most downstream adsorption chamber may be reduced, at least in part due to reducing the amount of adsorption by the adsorbent in the most downstream adsorption chamber during adsorption and increasing the amount of desorption during desorption. As a result, the blow-out performance in the soak time may be improved, thereby improving the Diurnal Breathing Loss (DBL) performance. Further, in the casing having the sub-case formed separately from the main-case, the adsorption heat generated by the adsorbent in the most upstream side adsorption chamber may be transferred to the most downstream side adsorption chamber via the contact portion between the main-case and the sub-case.

In accordance with another aspect of the present disclosure, a second embodiment may be the fuel vapor processing apparatus according to the first embodiment, wherein an adjacent portion between the most upstream side adsorption chamber and the most downstream side adsorption chamber are partitioned by a common wall shared by the main-case and the sub-case.

According to the second embodiment, the adsorption heat generated by the adsorbent in the most upstream side adsorption chamber may be transferred to the most downstream side adsorption chamber via the common wall.

In accordance with another aspect of the present disclosure, a third embodiment may be the fuel vapor processing apparatus according to the first or second embodiments, wherein a heat conductive member having a thermal conductivity higher than that of the main-case and the sub-case may be disposed on the wall portion interposed between the most upstream side adsorption chamber and the most downstream side adsorption chamber.

According to the third embodiment, the heat transfer efficiency from the most upstream side adsorption chamber to the most downstream side adsorption chamber may be improved by the heat conductive member disposed on the wall portion interposed between the most upstream side adsorption chamber and the most downstream side adsorption chamber.

In accordance with another aspect of the present disclosure, a fourth means may be the fuel vapor processing apparatus according to any one of the first to third embodiments, wherein a concave-convex portion that increases a heat transfer area may be formed as or on the surface of at least one adsorption chamber side of the wall portion interposed between the most upstream side adsorption chamber and the most downstream side adsorption chamber.

According to the fourth embodiment, the heat transfer efficiency from the most upstream side adsorption chamber to the most downstream side adsorption chamber may be improved by the concave-convex portion formed on the wall portion interposed between the most upstream side adsorption chamber and the most downstream side adsorption chamber.

In accordance with another aspect of the present disclosure, a fifth embodiment may be the fuel vapor processing apparatus according to any one of the first to fourth embodiments, wherein the most downstream adsorption chamber may be disposed adjacent to the intermediate adsorption chamber so as to be heat exchangeable. This allow the most downstream adsorption chamber to also transfer heat with the intermediate adsorption chamber. As a result, the adsorption capacity of the adsorbent in the most downstream adsorption chamber may be further reduced, which may also further reduce the amount of adsorption.

According to the fifth embodiment, at the time of adsorption, the most downstream side adsorption chamber may be heated due to the transfer of the adsorption heat generated by the adsorbent in the most upstream side adsorption chamber and the adsorption heat generated by the adsorbent in the intermediate adsorption chamber.

In accordance with another aspect of the present disclosure, a sixth embodiment may be the fuel vapor processing apparatus according to the fifth embodiments, wherein the casing may include a main-case and a sub-case. The main-case may comprise a first straight portion having the most upstream side adsorption chamber, a second straight portion having the intermediate adsorption chamber, and a connecting portion that connects the first straight portion and the second straight portion. Due to the arrangement of these portions, the main-case may be formed in a U-shape. The sub-case may be disposed in a recess formed between the first straight portion and the second straight portion of the main-case.

According to the sixth embodiment, in the casing having the sub-case formed separately from the main-case, the adsorption heat generated by both the adsorbent in the most upstream adsorption chamber and the adsorbent in the intermediate adsorption chamber may be transferred to the most downstream adsorption chamber, via the contact portion between the main-case and the sub-case.

In accordance with another aspect of the present disclosure, a seventh embodiment may be the fuel vapor processing apparatus according to the sixth embodiment, wherein adjacent portions between the most upstream side adsorption chamber and the most downstream side adsorption chamber, and between the intermediate adsorption chamber and the most downstream side adsorption chamber are partitioned by a common wall shared by the main-case and the sub-case.

According to the seventh embodiment, the adsorption heat generated by both the adsorbent in the most upstream adsorption chamber and the adsorbent in the intermediate adsorption chamber may be transferred to the most downstream adsorption chamber via the common wall.

In accordance with another aspect of the present disclosure, an eighth embodiment may be the fuel vapor processing apparatus according to any one of the sixth to seventh embodiments, wherein a heat conductive member, which may have a thermal conductivity higher than that of both the main-case and the sub-case, may be disposed on the wall portion interposed between the most upstream side adsorption chamber and the most downstream side adsorption chamber. The thermal conductive member may also be interposed between the intermediate adsorption chamber and the most downstream side adsorption chamber.

According to the eighth embodiment, the efficiency of the transfer of heat from the most upstream adsorption chamber to the most downstream chamber and from the intermediate adsorption chamber to the most downstream adsorption chamber may be improved. This is at least in part due to the heat conductive member disposed on the wall portion interposed between the most upstream side adsorption chamber and the most downstream side adsorption chamber and between the intermediate adsorption chamber and the most downstream side adsorption chamber.

In accordance with another aspect of the present disclosure, an ninth embodiment may be the fuel vapor processing apparatus according to any one of the sixth to eighth embodiments, wherein the concave-convex portion, which increases the heat transfer area, may be formed as or on at least one adsorption chamber side surface of the wall portion interposed between the most upstream side adsorption chamber and the most downstream side adsorption chamber, and between the intermediate adsorption chamber and the most downstream side adsorption chamber.

According to the ninth embodiment, the efficiency of the transfer of heat from the most upstream adsorption chamber to the most downstream adsorption chamber, and from the intermediate adsorption chamber to the most downstream adsorption chamber may be improved. This is at least in part due to the concave-convex portion formed on the wall interposed between the most upstream side adsorption chamber and the most downstream side adsorption chamber, and between the intermediate adsorption chamber and the most downstream side adsorption chamber.

In accordance with another aspect of the present disclosure, a tenth embodiment may be the fuel vapor processing apparatus according to the any one of the first to ninth embodiments, wherein the fuel vapor processing apparatus may be provided with a heat insulating member that covers the exposed portion(s), which are exposed to the outside of the sub-case. The heat insulating member has a heat retaining function.

According to the tenth embodiment, the heat retaining member, which covers the exposed portion(s) of the sub-case, may improve the heat retaining effect of the adsorption chamber on the most downstream side.

According to the present disclosure, the amount desorbed by the adsorbent in the most downstream adsorption chamber at the time of desorption may be increased. This may reduce the residual amount in the most downstream adsorption chamber.

### BRIEF DESCRIPTION OF THE DRAWINGS

FIG. 1 is a front, vertical, schematic cross-sectional view of a main canister and a sub canister according to a first embodiment.

FIG. 2 is a plan view of the canister of FIG. 1.

FIG. 3 is an enlarged, partial cross-sectional view of the canister of FIG. 1 illustrating a boundary part between the main-case body and the sub-case body.

FIG. 4 is a front, vertical, schematic cross-sectional view of a canister according to a second embodiment.

FIG. 5 is a plan view of the canister according of FIG. 2.

FIG. 6 is an enlarged, partial cross-sectional view of a canister according to a third embodiment, the view illustrating a boundary part between a main-case body and a sub-case body.

FIG. 7 is an enlarged, partial cross-sectional view of a canister according to a fourth embodiment, the view illustrating a boundary part between a main-case body and a sub-case body.

FIG. 8 is an enlarged, partial cross-sectional view of a canister according to a fifth embodiment, the view illustrating a boundary part between a main-case body and a sub-case body.

FIG. 9 is an enlarged, partial cross-sectional view of a canister according to a sixth embodiment, the view illustrating a boundary part between a main-case body and a sub-case body.

FIG. 10 is an enlarged, partial cross-sectional view of a canister according to a seventh embodiment, the view illustrating a boundary part between a main-case body and a sub-case body.

FIG. 11 is an enlarged, partial cross-sectional view of a canister according to an eighth embodiment, the view illustrating a boundary part between a main-case body and a sub-case body.

FIG. 12 is a plan view of a canister according to a ninth embodiment.

FIG. 13 is a vertical, schematic cross-sectional view of a canister according to a tenth embodiment.

FIG. 14 is a cross-sectional view of the canister of FIG. 13.

FIG. 15 is an exploded perspective view of the canister of FIG. 13.

FIG. 16 is a vertical schematic cross-sectional view of a canister according to an eleventh embodiment.

FIG. 17 is a cross-sectional view of the canister of FIG. 16.

FIG. 18 is an exploded perspective view of the canister of FIG. 16.

### DETAILED DESCRIPTION

As previously described, some fuel vapor processing apparatuses include a casing, a most upstream side adsorption chamber, and a most downstream side adsorption chamber. The casing forms a flow passage, through which an evaporated fuel flows from one end to the other end. A heat exchanger (air flow channel) extends between the most upstream side adsorption chamber and the most downstream side adsorption chamber. At the time of adsorption, the air, which has been heated due to the adsorption heat generated by the adsorbent in the most upstream side adsorption chamber, is cooled by the heat exchanger. Then, the most downstream adsorption chamber is cooled by the cooled air. Therefore, at the time of desorption, it becomes difficult for the evaporated fuel to be desorbed from the adsorbent in the most downstream adsorption chamber. Accordingly, an increased amount of residual adsorbed vapor (e.g., a residual amount of butane) may be maintained. This may reduce the blow-out performance during the soak time (in the inoperative state). In general, an adsorbent, such as activated carbon, has the characteristic that the higher the temperature, the smaller the amount of fuel that can be adsorbed. Additionally, the higher the temperature, the larger the amount of fuel that may be desorbed. On the other hand, the lower the temperature, the larger the amount of fuel that may be adsorbed and the smaller the amount of fuel that may be desorbed.

Therefore, there has conventionally been a need to reduce the residual amount of fuel vapor in the adsorbent in the most downstream adsorption chamber.

Embodiments in the present disclosure will now be described with reference to the figures.

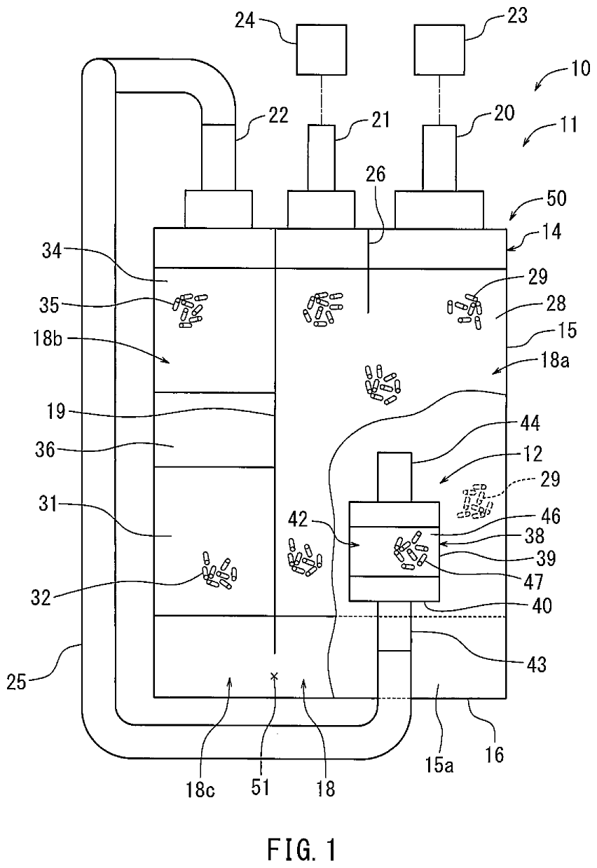

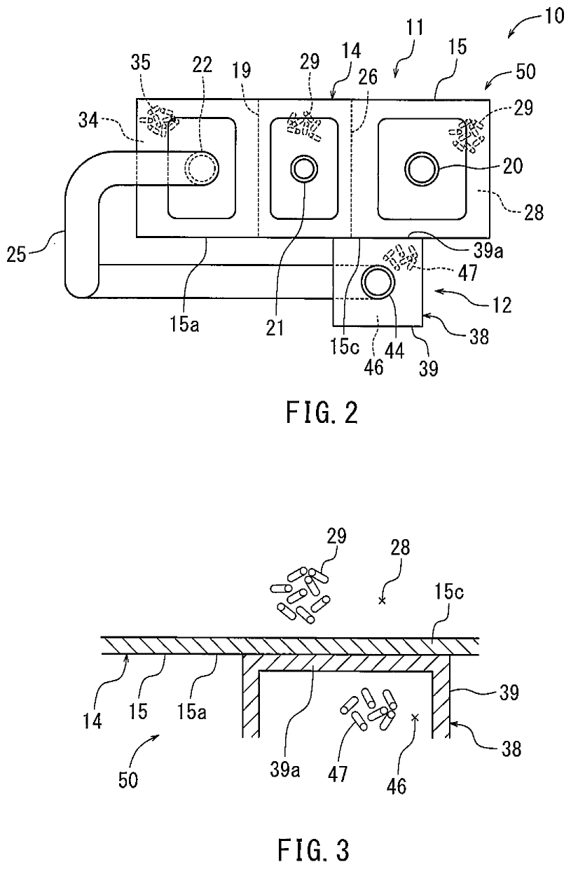

In a first embodiment, a canister installed in a vehicle, such as an automobile, equipped with an engine, such as an internal combustion engine, will be exemplified. FIG. 1 is a vertical, front cross-sectional view of a main canister and a sub canister according to the first embodiment. FIG. 2 is a plan view of the canister according to the first embodiment. For convenience of explanation, the vertical and horizontal directions of the canister are based on the orientation shown in FIG. 1. However, it should be appreciated that the mounting direction of the canister on the vehicle may set as appropriate.

As shown in FIG. 1, a canister 10 includes a main canister 11 and a sub canister 12 that is distinct and separate from the main canister 11. The canister 10 may be also referred to herein as “a fuel vapor processing apparatus” in the present disclosure.

The main canister 11 includes a main-case 14 having an elongate, square, box-shape. The main-case 14 includes a main-case body 15 and a main-case lid 16. The main-case 14 may be made of, for example, resin. In this embodiment, the main-case body 15 has a square tubular shape, with an upper surface thereof closed. The main-case lid 16 closes a lower surface opening in the main-case body 15. In general, the main-case body 15 and the main-case lid 16 may be joined by any suitable joining means, such as heat welding or adhesion.

A division wall 19 is provided in the main-case 14, so as to form a U-shaped main passage 18. The main passage 18 has a first passage 18a, a second passage 18b, and a communication part 18c in fluid communication with the lower ends of both passages 18a, 18b. In this embodiment, the first passage 18a is a straight portion on one side of the main passage 18 (the right side in FIG. 1), and the second passage 18b is a straight portion at the other side of the main passage (the left side in FIG. 1).

A tank port 20 and a purge port 21, both of which are in fluid communication with the first passage 18a, are formed on the upper wall portion of the main-case body 15. A main side connection port 22 in fluid communication with the second passage 18b is also be formed on the upper wall portion of the main-case body 15. The tank port 20 is a port for introducing evaporated fuel from a fuel tank 23 into the main passage 18. The purge port 21 is a port for purging the evaporated fuel from the main passage 18 to an intake passage of an engine 24. The main side connection port 22 is a port to which one end of a connection pipe 25 is connected. The upper end of the first passage 18a is partitioned by a partition wall 26 into a portion in fluid communication with the tank port 20 and a portion in fluid communication with the purge port 21.

The first passage 18a is provided with a first adsorption chamber 28. The first adsorption chamber 28 occupies most of the first passage 18a. The first adsorption chamber 28 stores a first adsorbent 29, such as activated carbon, configured to adsorb and desorb evaporated fuel. The second passage 18b is provided with a second adsorption chamber 31 and a third adsorption chamber 34, positioned in series. The third adsorption chamber 34 is disposed above the second adsorption chamber 31. The second adsorption chamber 31 stores a second adsorbent 32, such as activated carbon, configured to adsorb and desorb evaporated fuel. The third adsorption chamber 34 stores a third adsorbent 35, such as activated carbon, configured to adsorb and desorb evaporated fuel. An air chamber 36 is provided between the second adsorption chamber 31 and the third adsorption chamber 34.

The sub canister 12 includes a sub-case 38 having an elongate, square, box-shape. A sub-case body 39 of the sub-case 38 may be formed separately from the main-case body 15. The sub-case 38 includes the sub-case body 39 and a sub-case lid 40. The sub-case 38 may be made of, for example, resin. The sub-case body 39 has a square, tubular shape, with an upper surface thereof closed. The sub-case lid 40 closes a lower surface opening of the sub-case body 39. The sub-case body 39 and the sub-case lid 40 may be joined by any suitable joining means, such as heat welding or adhesion.

A sub passage 42, having a straight shape, is formed in the sub-case 38. A sub side connection port 43 in fluid communication with the sub-passage 42 is formed on the sub-case lid 40. The other end of the connection pipe 25, the end opposite that connected to the main side connection port 22, is connected to the sub side connection port 43. An atmospheric port 44 is formed on the upper wall of the sub-case body 39. The atmospheric port 44 may open to the atmosphere.

The sub passage 42 is provided with a fourth adsorption chamber 46. The fourth adsorption chamber 46 may occupy most of the sub passage 42. A fourth adsorbent 47 configured to adsorb and desorb evaporated fuel, such as activated carbon, is stored in the fourth adsorption chamber 46.

A casing 50 is generally composed of the main-case 14, the connecting pipe 25, and the sub-case 38. A flow passage 51, in which evaporated fuel flows from the tank port 20 side (an upstream side) to the atmospheric port 44 side (a downstream side) at the time of adsorption, is formed by the main passage 18, the sub passage 42, and the connection pipe 25. The tank port 20 side of the flow passage 51 may also be referred to as “one end” in the present disclosure. The atmospheric port 44 side of the flow passage 51 may also be referred to as “the other end” in the present disclosure.

As shown in FIG. 2, the sub-case body 39 may be attached to one of the side surfaces (e.g., the front surface) of the main-case body 15 by an attachment means, such as bolts, adhesive tape, adhesive, or welding. The sub-case body 39 is disposed on a front-side wall 15a of the main-case body 15 at a position corresponding to the first adsorption chamber 28. For instance, it may be at a position corresponding to the lower end portion of the first adsorption chamber 28 (e.g., see FIG. 1). The lower end of the first adsorption chamber 28 correspond to the downstream end of the flow of evaporated fuel during adsorption.

As shown in FIG. 3, a rear-side wall 39a of the sub-case body 39 is in contact with the front-side wall 15a of the main-case body 15. As a result, the first adsorption chamber 28 and the fourth adsorption chamber 46 are disposed adjacent to each other, so as to allow heat to be exchanged therebetween. The portion of the front-side wall 15a of the main-case body 15 that contacts the rear-side wall 39a of the sub-case body 39 may also be referred to herein as a contact wall portion 15c.

The main-case body 15 may also be referred to as the “main-case body” in the present disclosure. The sub-case body 39 may correspond to the “sub-case body” in the present disclosure. The first adsorption chamber 28 may also be referred to as the “most upstream side adsorption chamber” in the present disclosure. The fourth adsorption chamber 46 may also be referred to as the “most downstream adsorption chamber” in the present disclosure. The second adsorption chamber 31 and the third adsorption chamber 34 may each be referred to as the “intermediate adsorption chamber” in the present disclosure. The contact portion between the front-side wall 15a of the main-case body 15 and the rear-side wall 39a of the sub-case body 39 may be referred to as a wall portion interposed between the first adsorption chamber 28 and the fourth adsorption chamber 46. The same adsorbent may be used for the first adsorbent 29, the second adsorbent 32, the third adsorbent 35, and the fourth adsorbent 47. Alternatively, different adsorbents may be used.

The effect of the canister 10 at the time of adsorption (mainly at the time of refueling) will be described. Evaporated fuel containing air in the fuel tank 23 is introduced from the tank port 20 into the flow passage 51 of the casing 50. The evaporated fuel flows through the first adsorption chamber 28, the second adsorption chamber 31, the third adsorption chamber 34, and the fourth adsorption chamber 46, in this order, to reach the atmospheric port 44. At that time, the evaporated fuel is sequentially adsorbed on the first adsorbent 29, the second adsorbent 32, the third adsorbent 35, and the fourth adsorbent 47. After the evaporated fuel has been adsorbed, air is then be discharged from the atmospheric port 44.

At the time of adsorption, each of the adsorbents 29, 32, 35, 47 generate adsorption heat in response to adsorbing the evaporated fuel. In particular, the adsorption heat generated by the first adsorbent 29 is relatively high. This adsorption heat tends to accumulate on the downstream side of the first adsorption chamber 28. The adsorption heat generated by the first adsorbent 29 is transferred to the fourth adsorption chamber 46, via the contact wall portion 15c of the front-side wall 15a of the main-case body 15 and the rear-side wall 39a of the sub-case body 39. As a result, the fourth adsorption chamber 46 is heated, which may cause the adsorption capacity of the fourth adsorbent 47 to be reduced and may cause the adsorption amount to be reduced.

Next, the effect of the canister 10 at the time of soaking (for instance, when parked) will be described. At the time of soaking (for instance, when parked), the fourth adsorption chamber 46 may be kept warm by receiving the adsorption heat and residual heat of the first adsorbent 29 of the first adsorption chamber 28.

Next, the effect of the canister 10 at the time of desorption (for instance, during a purging operation) will be described. At the time of desorption (for instance, during a purging operation), the intake negative pressure of the engine 24 acts on the purge port 21 to create flow within the flow passage 51 of the casing 50. Along with this, atmospheric air (fresh air) is introduced from the atmospheric port 44 into the flow passage 51 of the casing 50. The air flows in a path opposite to that at the time of adsorption. As a result, the evaporated fuel is sequentially desorbed from the fourth adsorbent 47, the third adsorbent 35, the second adsorbent 32, and the first adsorbent 29. The desorbed fuel vapor is purged from the purge port 21 to the engine 24.

According to the canister 10 described above, at the time of adsorption, the fourth adsorption chamber 46 is heated by the transfer of the adsorption heat generated by the first adsorbent 29. Therefore, the adsorption capacity of the fourth adsorbent 47 and the amount of adsorption may be reduced. Further, at the time of desorption, if residual heat remains in the fourth adsorption chamber 46, the amount of desorption by the fourth adsorbent 47 may be larger than that at ambient temperature. Therefore, the residual amount of fuel vapor on the fourth adsorbent 47 may be reduced, due to reducing the amount of adsorption of the fourth adsorbent 47 at the time of adsorption and increasing the amount of desorption at the time of desorption. As a result of the reduced residual amount of fuel vapor on the fourth adsorbent 47, the blow-by performance at the time of soaking may be improved and the Diurnal Breathing Loss (DBL) performance may be improved.

Further, the fourth adsorption chamber 46 is disposed adjacent to the downstream end of the first adsorption chamber 28, so as to allow heat to be exchanged therebetween. Accordingly, the heat exchange efficiency may be improved, as compared with the case where the fourth adsorption chamber 46 is disposed at a position other than the downstream end portion of the first adsorption chamber 28 (for example, at the upstream end portion). The fourth adsorption chamber 46 is disposed so it may exchange heat with a portion other than the downstream end portion of the first adsorption chamber 28.

Further, even though the casing 50 includes a sub-case body 39 formed separately from a main-case body 15, the adsorption heat generated by the first adsorbent 29 is transferred to the fourth adsorption chamber 46, via the contact wall portion 15c of the front-side wall 15a of the main-case body 15 and the rear-side wall 39a of the sub-case body 39.

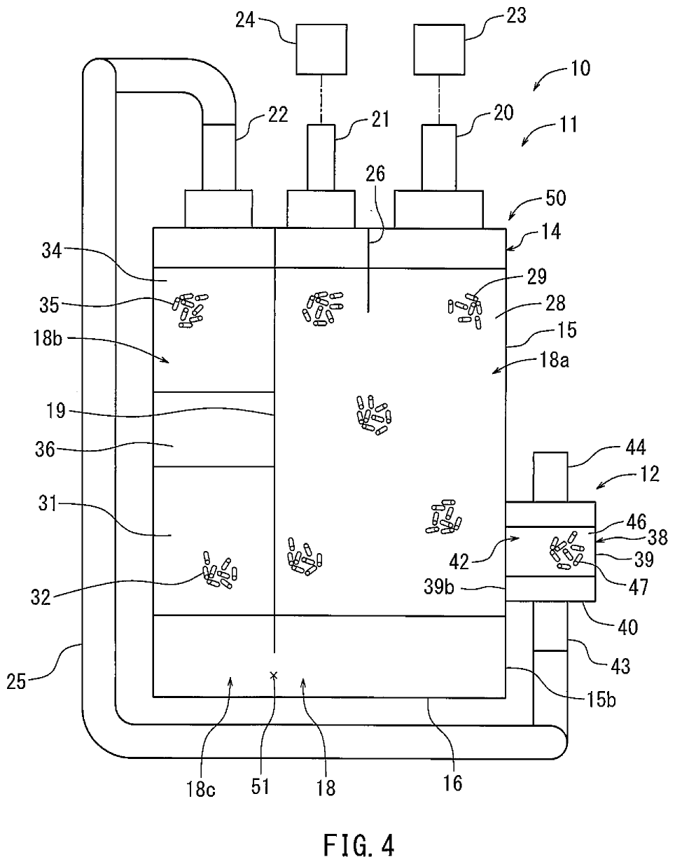

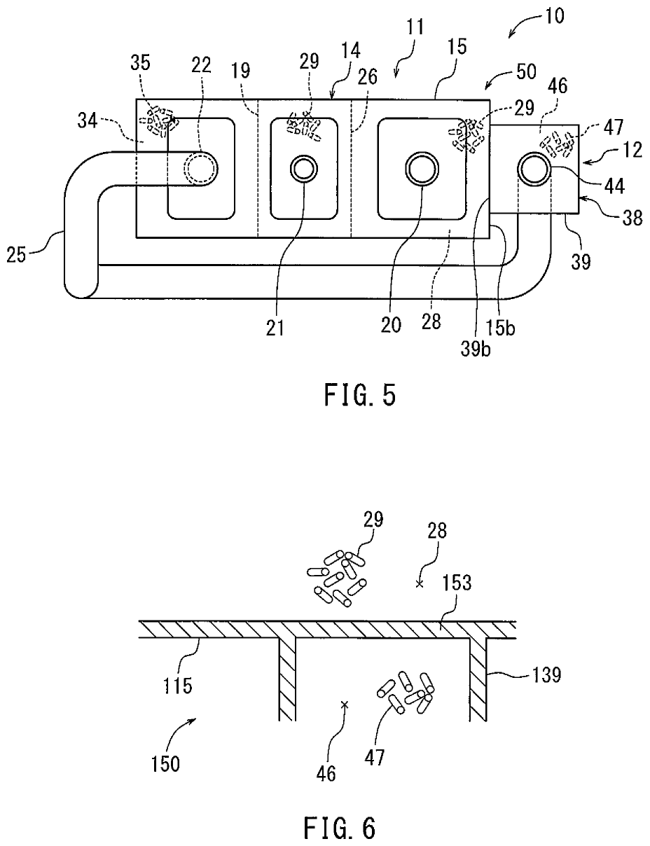

A second embodiment is a modification of the positioning of the sub canister 12 of the first embodiment (see FIGS. 1 and 2). For purposes of clarity and conciseness, the modified parts will be described, while the parts that are substantially the same as those of the first embodiment will be designated by the same reference numerals and the corresponding description thereof will be omitted. FIG. 4 is a vertical sectional view of the canister, from the front of the canister, according to the second embodiment. FIG. 5 is a plan view of the canister according to the second embodiment.

As shown in FIG. 4, the sub-case body 39 is attached to one of the side surfaces (for instance, the right side surface) of the main-case body 15 by any suitable attachment means, such as bolts, adhesive tape, adhesive, or welding. The sub-case body 39 is disposed at a position corresponding to the first adsorption chamber 28 on a right side wall 15b of the main-case body 15. Particularly, the sub-case body 39 is at a position corresponding to the lower end portion of the first adsorption chamber 28. The lower end of the first adsorption chamber 28 corresponds to the downstream end of the flow of evaporated fuel during adsorption. Further, the left side wall 39b of the sub-case body 39 is in contact with the right side wall 15b of the main-case body 15 (see FIG. 5). As a result, the first adsorption chamber 28 and the fourth adsorption chamber 46 are disposed adjacent to each other, so as to allow for the exchange of heat. Consequently, substantially the same effects as those in the first embodiment may be realized by the second embodiment. The wall portion of the right side wall 15b of the main-case body 15, the part that contacts the left side wall 39b of the sub-case body 39, may also be referred to as the “contact wall portion” in the present disclosure.

A third embodiment is a modification of the contact portion between the main-case body 15 and the sub-case body 39 of the first embodiment (see FIG. 3). For purposes of clarity and conciseness, the modified parts will be described, while the parts that are substantially the same as those of the first embodiment will be designated by the same reference numerals and the corresponding description thereof will be omitted. FIG. 6 is a part of a cross-sectional view of the canister according to a third embodiment, showing a boundary part between the main-case body and the sub-case body. Reference numerals in the one-hundreds (100s) are added to the parts that are modified in the third embodiment.

As shown in FIG. 6, the main-case body 115 and a sub-case body 139 of a casing 150 are molded. The first adsorption chamber 28 and the fourth adsorption chamber 46 are partitioned via a common wall 153, which is a wall common to the main-case body 115 and the sub-case body 139. The common wall 153 corresponds to a wall portion interposed between the first adsorption chamber 28 and the fourth adsorption chamber 46. The main-case body 115 may also be referred to as the “main-case body” in the present disclosure. The sub-case body 139 may also be referred to as the “sub-case body” in the present disclosure.

According to the third embodiment, in the casing 150 that includes the sub-case body 139 formed with the main-case body 115, the adsorption heat generated by the first adsorbent 29 is transferred to the fourth adsorption chamber 46 via the common wall 153. The modifications described with respect to the third embodiment may be applied to the casing 50 of the second embodiment (see FIGS. 3 and 4).

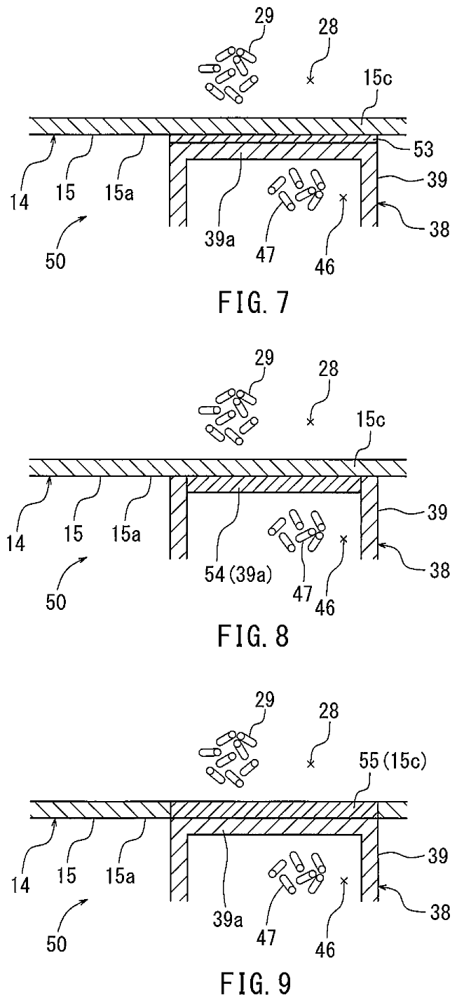

A fourth embodiment is a modification of the contact portion between the main-case body 15 and the sub-case body 39 of the first embodiment (see FIG. 3). For purposes of clarity and conciseness, the modified parts will be described, while the parts that are substantially the same as those of the first embodiment will be designated by the same reference numerals and the corresponding description thereof will be omitted. FIG. 7 is a part of a cross-sectional view of a canister according to a fourth embodiment. FIG. 7 shows a boundary part between the main-case body and the sub-case body.

As shown in FIG. 7, a heat conductive member 53 having a flat, plate shape is interposed between the contact wall portion 15c of the front-side wall 15a of the main-case body 15 and the rear-side wall 39a of the sub-case body 39. The heat conductive member 53 is in contact with the contact wall portion 15c and the rear-side wall 39a. The heat conductive member 53 may be made of, for example, a metal, such as iron or aluminum, and may have a higher thermal conductivity than the thermal conductivity of both of the case bodies 15, 39.

According to the fourth embodiment, the heat transfer efficiency from the first adsorption chamber 28 to the fourth adsorption chamber 46 may be improved at least in part due to the heat conductive member 53, which is disposed between the contact wall portion 15c of the front-side wall 15a of the main-case body 15 and the rear-side wall 39a of the sub-case body 39.

A fifth embodiment is a modification of the contact portion between the main-case body 15 and the sub-case body 39 of the first embodiment (see FIG. 3). For purposes of clarity and conciseness, the modified parts will be described, while the parts that are substantially the same as those of the first embodiment will be designated by the same reference numerals and the description thereof will be omitted. FIG. 8 is a part of a cross-sectional view of a canister according to a fifth embodiment, showing a boundary part between the main-case body and the sub-case body.

As shown in FIG. 8, a heat conductive member 54, which may have a flat, plate shape, serves as the rear-side wall 39a of the sub-case body 39. The heat conductive member 54 is integral with the sub-case body 39, for example by insert molding. The heat conductive member 54 has a relatively high thermal conductivity, similar to the heat conductive member 53 of the fourth embodiment (see FIG. 7). The heat conductive member 54 is in contact with the contact wall portion 15c of the main-case body 15.

According to the fifth embodiment, the heat transfer efficiency from the first adsorption chamber 28 to the fourth adsorption chamber 46 may be improved at least in part due to the heat conductive member 54, which also serves as the rear-side wall 39a of the sub-case body 39 in this embodiment.

A sixth embodiment is a modification of the contact portion between the main-case body 15 and the sub-case body 39 of the first embodiment (see FIG. 3). For purposes of clarity and conciseness, the modified parts will be described, while the parts that are substantially the same as those of the first embodiment will be designated by the same reference numerals and the description thereof will be omitted. FIG. 9 is a part of a cross-sectional view of a canister according to a sixth embodiment, showing a boundary part between the main-case body and the sub-case body.

As shown in FIG. 9, a heat conductive member 55, which may have a flat, plate shape, serves as the contact wall portion 15c of the main-case body. The heat conductive member 55 is integral with the front-side wall 15a of the main-case body 15, for instance by insert molding. The heat conductive member 55 has a relatively high thermal conductivity, similar to the heat conductive member 53 of the fourth embodiment (see FIG. 7). The heat conductive member 55 is in contact with the rear-side wall 39a of the sub-case body 39.

According to the sixth embodiment, the heat transfer efficiency from the first adsorption chamber 28 to the fourth adsorption chamber 46 may be improved at least in part due to the heat conductive member 55, which also serves as the contact wall portion 15c of the front-side wall 15a of the main-case body 15 in this embodiment.

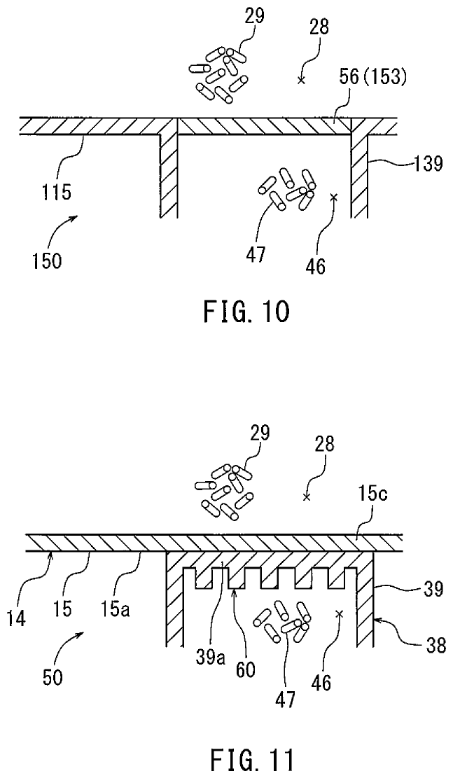

A seventh embodiment is a modification of the common wall portion 153 of the casing 150 of the third embodiment (see FIG. 6). For purposes of clarity and conciseness, the modified parts will be described, while the parts that are substantially the same as those of the third embodiment will be designated by the same reference numerals and the description thereof will be omitted. FIG. 10 is a part of a cross-sectional view of a canister according to a seventh embodiment, showing a boundary part between the main-case body and the sub-case body.

As shown in FIG. 10, a heat conductive member 56, which may have a flat, plate shape, serves as the common wall 153 between the first adsorption chamber 28 and the fourth adsorption chamber 46. The heat conductive member 56 is integral with the casing 150, for instance by insert molding. The heat conductive member 56 has a relatively high thermal conductivity, similar to the heat conductive member 53 of the fourth embodiment (see FIG. 7).

According to the seventh embodiment, the heat transfer efficiency from the first adsorption chamber 28 to the fourth adsorption chamber 46 may be improved at least in part due to the heat conductive member 56, which also serves as the common wall 153 of the casing 150.

An eighth embodiment is a modification of the contact portion between the main-case body 15 and the sub-case body 39 of the first embodiment (see FIG. 3). For purposes of clarity and conciseness, the modified parts will be described, while the parts that are substantially the same as those of the first embodiment will designated by the same reference numerals and the description thereof will be omitted. FIG. 11 is a part of a cross-sectional view of a canister according to an eighth embodiment, showing a boundary part between the main-case body and the sub-case body.

As shown in FIG. 11, a concave-convex portion 60, which is configured to increase the heat transfer area, is formed on the fourth adsorption chamber 46 side surface of the rear-side wall 39a of the sub-case body 39.

According to the eighth embodiment, the heat transfer efficiency from the first adsorption chamber 28 to the fourth adsorption chamber 46 may be improved at least in part due to the concave-convex portion 60 formed on the rear-side wall 39a of the sub-case body 39. In other embodiments, the concave-convex portion 60 is formed on the first adsorption chamber 28 side of the contact wall portion 15c of the front-side wall 15a of the main-case body 15. In yet other embodiments, the concave-convex portion 60 is formed as the common wall 153 of the third embodiment at the first adsorption chamber 28 side and/or at the fourth adsorption chamber 46 side (see FIG. 6).

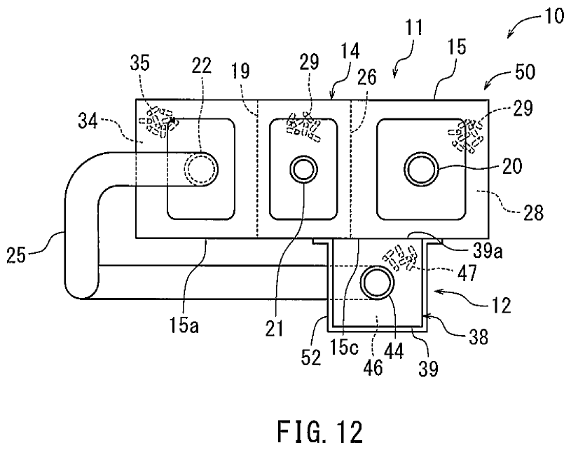

A ninth embodiment is a modification of the sub canister 12 of the first embodiment (see FIGS. 1 and 2). For purposes of clarity and conciseness, the modified parts will be described, while the parts that are substantially the same as those of the first embodiment will be designated by the same reference numerals and the description thereof will be omitted. FIG. 12 is a plan view of a canister according to a ninth embodiment.

As shown in FIG. 12, an insulating sheet 52 having a heat retaining function is attached to the portion(s) of the sub-case 38 exposed to the outside. Specifically, the insulating sheet 52 is disposed so as to cover the front surface, the right side surface, and/or the left side surface of the sub-case body 39. The insulating sheet 52 may also be referred to as the “heat insulating member” in the present disclosure.

According to the ninth embodiment, the heat retaining effect of the fourth adsorption chamber 46 may be improved at least in part due to the insulating sheet 52 covering the exposed portion(s) of the sub-case 38. Further, the insulating sheet 52 is provided so as to completely cover the exposed portion(s) of the sub-case 38.

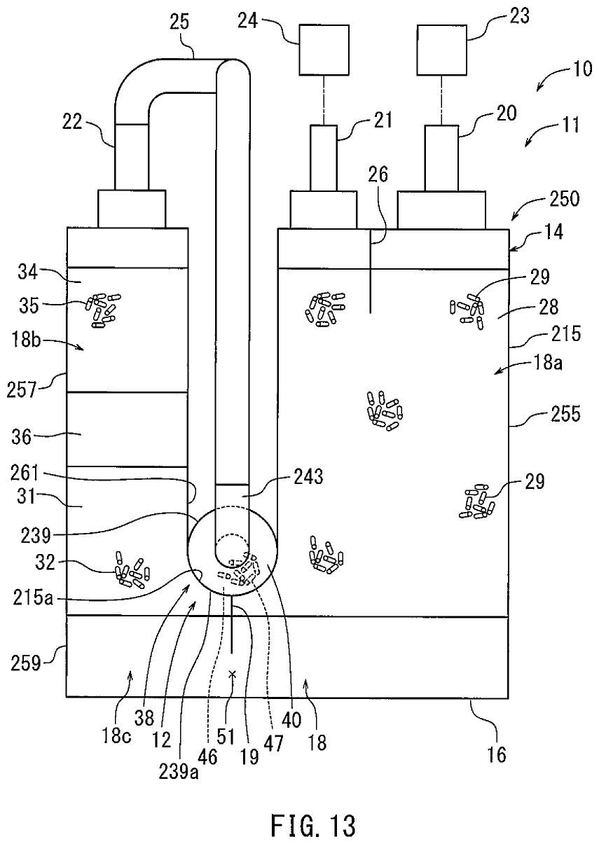

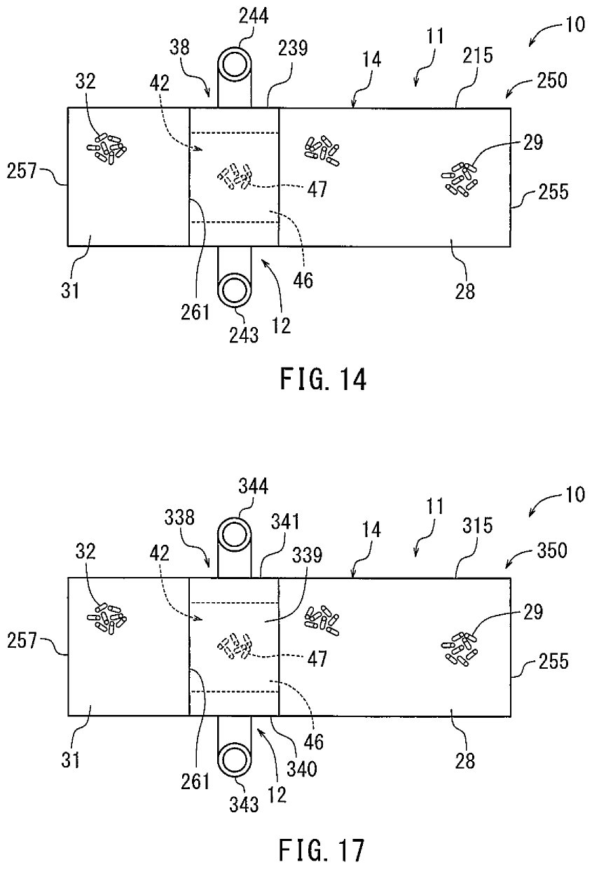

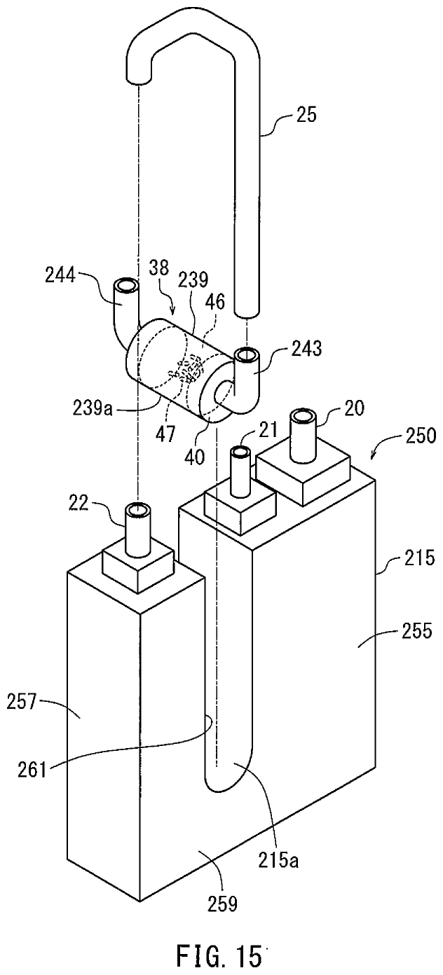

A tenth embodiment is a modification of the arrangement of the sub canister 12 of the first embodiment (see FIGS. 1 and 2). For purposes of clarity and conciseness, the modified parts will be described, while the parts that are substantially the same as those of the first embodiment will be designated by the same reference numerals and the description thereof will be omitted. FIG. 13 is a vertical sectional view of a canister according to a tenth embodiment. FIG. 14 is a cross-sectional view of the canister according to a tenth embodiment. FIG. 15 is an exploded perspective view of the canister according to the tenth embodiment. Reference numerals in the two-hundreds (200s) correspond to the parts of the first embodiment that are to be modified in the tenth embodiment. As shown in FIG. 15, a casing 250 may include a main-case body 215 and a sub-case body 239.

As shown in FIG. 13, the main-case body 215 is formed generally in a U-shape, having a first straight portion 255, a second straight portion 257, and a connecting portion 259. The first straight portion 255 has a first adsorption chamber 28. The second straight portion 257 has a second adsorption chamber 31, a third adsorption chamber 34, and an air chamber 36. The connecting portion 259 connect the first straight portion 255 and the second straight portion 257. A U-shaped recess 261 is formed between the first straight portion 255 and the second straight portion 257 (see FIG. 15). The bottom of the recess 261 is disposed near the lower ends of the first adsorption chamber 28 and the second adsorption chamber 31. The lower ends of the first and second adsorption chambers 28, 31 are positioned above the lower surfaces of each respective adsorption chamber 28, 31.

The sub-case body 239 is formed separately from the main-case body 215. The sub-case body 239 has a fourth adsorption chamber 46. The sub-case 239 is disposed horizontally on the bottom of the recess 261 of the main-case body 215 (see FIG. 14). The sub-case body 239 may be attached to the main-case body 215 by any suitable attachment means, such as bolts, adhesive tape, adhesion, or welding. A sub side connecting port 243 and an atmospheric port 244 are each formed in an L-shaped tubular shape, with the open ends being directed upward (see FIG. 15).

The sub-case body 239 has a cylindrical shape that fits into the bottom of the recess 261 of the main-case body 215, with almost no gap. That is, a semi-cylindrical lower half peripheral wall 239a in the lower half of the sub-case body 239 is in contact with a semi-cylindrical bottom wall 215a of the recess 261 of the main-case body 215. As a result, the fourth adsorption chamber 46 is disposed adjacent to not only the first adsorption chamber 28 but also the second adsorption chamber 31. In particular, they are so positioned so as to allow heat to be exchangeable therebetween. The adsorption heat of the first adsorbent 29 and the adsorption heat of the second adsorbent 32 are transferred to the fourth adsorption chamber 46 via a total of three surfaces, that is, the right side surface, the lower surface, and the left side surface of the contact portion between the main-case body 215 and the sub-case body 239. Further, the contact portion between the bottom wall 215a of the recess 261 of the main-case body 215 and the lower half peripheral wall 239a of the sub-case body 239 correspond to a wall portion interposed between the first adsorption chamber 28 and the fourth adsorption chamber 46 and between the second adsorption chamber 31 and the fourth adsorption chamber 46.

Similar effects as those of the first embodiment may be realized by the tenth embodiment. Further, at the time of adsorption, the fourth adsorption chamber 46 may be heated due to the transfer of heat from both the adsorption heat generated by the first adsorbent 29 and the adsorption heat generated by the adsorbent of the second adsorption chamber 31. Therefore, at the time of adsorption, the adsorption capacity of the fourth adsorbent 47 and the amount of adsorption may be further reduced.

Further, the sub-case body 239 is disposed in the recess 261. The recess 261 has a substantially a U-shaped portion formed between the first straight portion 255 and the second straight portion 257 of the main-case body 215 of the casing 250. As a result, the fourth adsorption chamber 46 of the sub-case body 239 is disposed so as to be able to exchange heat with both the first adsorption chamber 28 and the second adsorption chamber 31 of the main-case body 215.

Further, even though the sub-case body 239 is formed separately from the main-case body 215, the adsorption heat generated by the first adsorbent 29 and the second adsorbent 32 is transferred to the fourth adsorption chamber 46, via the contact portion between the main-case body 215 and the sub-case body 239.

In the tenth embodiment, the following means may be taken in order to further improve the heat transfer efficiency from both the first adsorption chamber 28 and the second adsorption chamber 31 to the fourth adsorption chamber 46:

(1) Similar to the fourth embodiment (see FIG. 7), a heat conductive member may be disposed between the bottom wall 215a of the recess 261 of the main-case body 215 and the lower half peripheral wall 239a of the sub-case body 239.
(2) Similar to the fifth embodiment (see FIG. 8), a heat conductive member, which also serves as the lower half peripheral wall 239a, may be integrated with the sub-case body 239, for instance by insert molding.
(3) Similar to the sixth embodiment (see FIG. 9), a heat conductive member, which also serves as the bottom wall 215a of the recess 261, may be integrated with the main-case body 215, for instance by insert molding.
(4) Similar to the eighth embodiment (see FIG. 11), a concave-convex portion may be formed on the surface of the fourth adsorption chamber 46 side of the lower half peripheral wall 239a of the sub-case body 239. Alternatively or in addition, the concave-convex portion may be formed on the surfaces of the first adsorption chamber 28 side and the second adsorption chamber 31 side of the bottom wall 215a of the recess 261 in the main-case body 215.

In the tenth embodiment, in order to improve the heat retaining effect of the fourth adsorption chamber 46, an insulating sheet is provided to cover the exposed portion(s) of the sub-case 38, similar to the ninth embodiment (see FIG. 12).

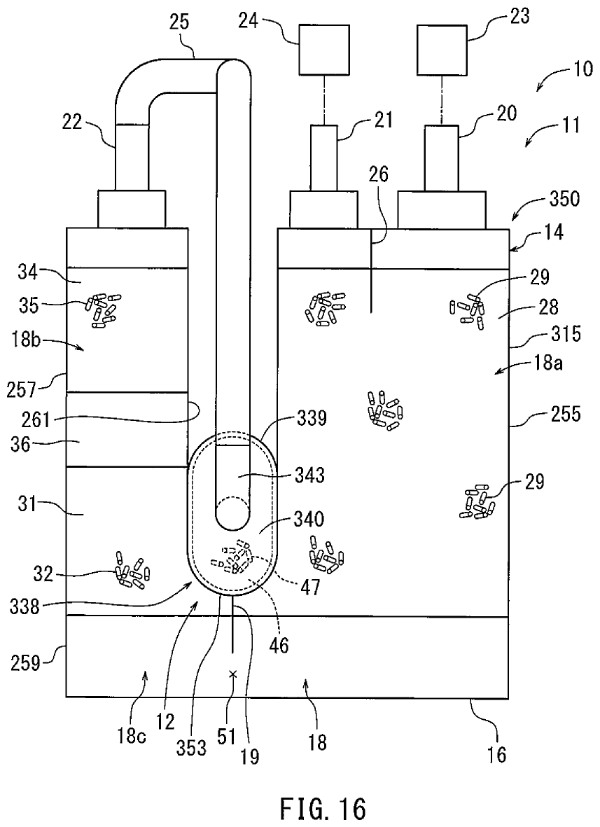

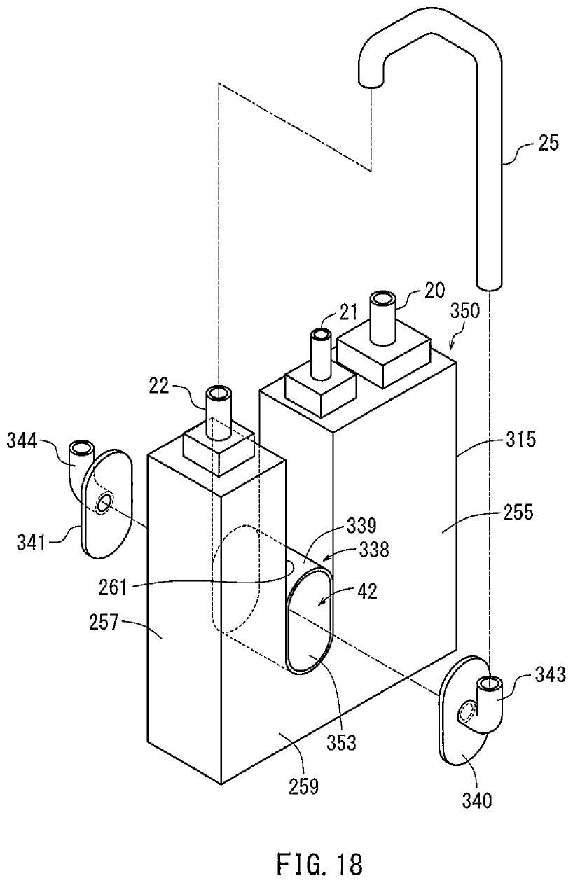

An eleventh embodiment is a modification of the contact portion between the main-case body 215 and the sub-case body 239 of the tenth embodiment (see FIGS. 13 to 15). For purposes of clarity and conciseness, the modified parts will be described, while the parts that are substantially the same as those in the tenth embodiment will be designated by the same reference numerals and the description thereof will be omitted. FIG. 16 is a vertical sectional view of a canister according to an eleventh embodiment. FIG. 17 is a cross-sectional view of the canister according to the eleventh embodiment. FIG. 18 is an exploded perspective view of the canister according to the eleventh embodiment. Reference numerals in the three-hundreds (300s) are added to the parts of the tenth embodiment that are to be changed in the eleventh embodiment.

As shown in FIG. 17, a sub-case 338 includes a sub-case body 339, a front sub-case lid 340, and a rear-side sub-case lid 341 (see FIG. 18). The sub-case body 339 extends in the front-rear direction (vertical direction in FIG. 17) and has a substantially elliptic cylindrical shape. The front sub-case lid 340 closes the front opening of the sub-case body 339. The rear sub-case lid 341 closes the rear opening of the sub-case body 339. The sub-case 338 may be made of, for example, resin. In the eleventh embodiment, the sub-case body 339 is formed in an elliptic cylindrical shape that is elongated in the vertical direction.

As shown in FIG. 18, the main-case body 315 and the sub-case body 339 of a casing 350 may be molded. That is, the main-case body 315 and the sub-case body 339 may be connected to each other via a common wall 353. The first adsorption chamber 28 and the fourth adsorption chamber 46, and the second adsorption chamber 31 and the fourth adsorption chamber 46 may be partitioned by the common wall 353 (see FIG. 16). The common wall 353 corresponds to a wall portion interposed between the first adsorption chamber 28 and the fourth adsorption chamber 46 and between the second adsorption chamber 31 and the fourth adsorption chamber 46. The main-case body 315 may also be referred to as the “main-case” in the present disclosure. The sub-case body 339 may also be referred to as the “sub-case” in the present disclosure.

As shown in FIG. 17, the sub-case body 339 and the sub-case lids 340, 341 may be joined using any suitable joining means, such as heat welding or adhesives. A sub-side connection port 343, which communicates with the sub-passage 42, is formed on the front-side sub-case lid 340. The other end of the connection pipe 25, which is opposite to the end connected to the main side connection port 22, is connected to the sub-side connection port 343 (see FIG. 16). Further, an atmospheric port 344, which communicates with the sub passage 42, is formed on the rear sub-case lid 341.

According to the eleventh embodiment, even if the sub-case body 339 is formed with the main-case body 315, the adsorption heat generated by the first adsorbent 29 and the second adsorbent 32 is transferred to the fourth adsorption chamber 46 via the common wall 353.

In the eleventh embodiment, the following means may be taken in order to further improve the heat transfer efficiency from the first adsorption chamber 28 and the second adsorption chamber 31 to the fourth adsorption chamber 46:

(1) Similar to the seventh embodiment (see FIG. 10), a heat conductive member, which also serves as the common wall 353, may be integrated with the casing 350, for instance by insert molding.
(2) Similar to the eighth embodiment (see FIG. 11), a concave-convex portion may be formed on the surface of the fourth adsorption chamber 46 side of the common wall 353. Alternatively or in addition, another concave-convex portion may be formed on the surfaces of the first adsorption chamber 28 side and the second adsorption chamber 31 side of the common wall 353.

In the eleventh embodiment, in order to improve the heat retaining effect of the fourth adsorption chamber 46, an insulating sheet is provided to cover the exposed portion(s) of the sub-case 338, as in the ninth embodiment (see FIG. 12).

The arts disclosed in the present disclosure is not limited to the above-described embodiment, and may be implemented in various other embodiments. For example, the shapes of the casings 50, 150, 250 may be changed, as appropriate. Further, the number of intermediate adsorption chambers may be at least one. Further, as the adsorbent, a honeycomb-structured adsorbent may be used instead of activated carbon.

The various examples described above in detail with reference to the attached drawings are intended to be representative in the present disclosure and are thus non-limiting embodiments. The detailed description is intended to teach a person of skill in the art to make, use, and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved fuel vapor processing apparatus, and/or methods of making and using the same.

What is claimed is:

1. A fuel vapor processing apparatus, comprising:
a casing forming a flow passage through which an evaporated fuel flows from a first end to a second end;
a most upstream side adsorption chamber disposed at the first end of the flow passage and configured to store a first adsorbent for adsorbing and desorbing the evaporated fuel;
a most downstream side adsorption chamber disposed at the second end of the flow passage and configured to store a second adsorbent for adsorbing and desorbing the evaporated fuel; and
an intermediate adsorption chamber disposed in series between the most upstream side adsorption chamber and the most downstream side adsorption chamber, wherein the intermediate adsorption chamber is configured to store a third adsorbent for adsorbing and desorbing the evaporated fuel, wherein:
the casing comprises:
a main-case including the most upstream side adsorption chamber and the intermediate adsorption chamber; and
a sub-case formed separately from the main-case and including the most downstream adsorption chamber,
the most downstream adsorption chamber of the sub-case and the most upstream side adsorption chamber are disposed adjacent to each other without a gap on a downstream side than a center of the most upstream side adsorption chamber in a flowing direction of evaporated fuel during adsorption, and
the most upstream side adsorption chamber and the most downstream side adsorption chamber are configured to exchange heat therebetween.

2. The fuel vapor processing apparatus of claim 1, wherein an adjacent portion between the most upstream side adsorption chamber and the most downstream side adsorption chamber are partitioned by a common wall shared by the main-case and the sub-case.

3. The fuel vapor processing apparatus of claim 1, wherein a heat conductive member having a thermal conductivity higher than a thermal conductivity of the casing is disposed as or on a wall portion interposed between the most upstream side adsorption chamber and the most downstream side adsorption chamber.

4. The fuel vapor processing apparatus of claim 1, wherein a concave-convex portion configured to increase a heat transfer area is formed on a surface of at least one adsorption chamber side of a wall portion interposed between the most upstream side adsorption chamber and the most downstream side adsorption chamber.

5. The fuel vapor processing apparatus of claim 1, wherein:
the most downstream adsorption chamber is disposed adjacent to the intermediate adsorption chamber, and
the most downstream side adsorption chamber and the intermediate adsorption chamber are configured to exchange heat therebetween.

6. The fuel vapor processing apparatus of claim 5, wherein:
a main-case including a first straight portion having the most upstream side adsorption chamber, a second straight portion having the intermediate adsorption chamber, and a connecting portion connecting the first straight portion and the second straight portion, thereby forming a U-shape; and
a sub-case is disposed in a recess between the first straight portion and the second straight portion of the main-case.

7. The fuel vapor processing apparatus of claim 6, wherein adjacent portions between the most upstream side adsorption chamber and the most downstream side adsorption chamber and between the intermediate adsorption chamber and the most downstream side adsorption chamber are partitioned by a common wall shared by the main-case and the sub-case.

8. The fuel vapor processing apparatus of claim 6, wherein a heat conductive member having a thermal conductivity higher than a thermal conductivity of the casing is disposed on a wall portion interposed between the most upstream side adsorption chamber and the most downstream side adsorption chamber and between the intermediate adsorption chamber and the most downstream side adsorption chamber.

9. The fuel vapor processing apparatus of claim 6, wherein a concave-convex portion configured to increase a heat transfer area is formed on at least one adsorption chamber side surface of a wall portion interposed between the most upstream side adsorption chamber and the most downstream side adsorption chamber and between the intermediate adsorption chamber and the most downstream side adsorption chamber.

10. The fuel vapor processing apparatus of claim 1, wherein:
a heat insulating member is positioned to cover an exposed portion of the sub-case exposed to the outside,
the heat insulating member is adjacent the most downstream adsorption chamber, and
the heat insulating member is configured to retain heat.
